(19) United States
(12) Patent Application Publication
(10) Pub. No.: US 2022/0154761 A1
(43) Pub. Date: May 19, 2022

(54) Suction Cup Having An Effortless Release

(71) Applicant: Tom Van Esch, Commerce, MI (US)

(72) Inventor: Tom Van Esch, Commerce, MI (US)

(21) Appl. No.: 17/526,038

(22) Filed: Nov. 15, 2021

Related U.S. Application Data
(60) Provisional application No. 63/115,117, filed on Nov. 18, 2020.

(51) Int. Cl. F16B 47/00

(52) U.S. Cl. CPC F16B 47/006

(57) ABSTRACT

An apparatus and method for preventing the unintentional formation of a vacuum below a suction cup prior to raising a central part of a suction cup to intentionally create a vacuum to attach the suction cup to a surface, including forming a series of separate bumps circumferentially spaced apart from each other and projecting down from the suction cup and engaging a surface to which the suction cup is to be attached.

### CROSS REFERENCE TO RELATED APPLICATIONS

This application claims the benefit of U.S. provisional patent application No. 63/115,117 filed on Nov. 18, 2020.

### BACKGROUND OF THE INVENTION

Suction cups are a generally accepted means to temporarily attach something to a smooth surface. Suction cups are based on creating a vacuum under a flexible body so that the atmospheric pressure provides the necessary contact force to ensure adhesion.

Many types of devices are commercially available to generate a vacuum for this purpose. If the suction cup has to be removed from the surface this action needs to be reversed, i.e., the vacuum beneath the suction cup needs to be dissipated and replaced with air at atmospheric pressure to relieve the vacuum force. When atmospheric pressure is reestablished under suction cup, there will no longer be an attractive force, allowing easy removal of the suction cup.

Some current designs require a significant pull force to be applied, so as to create a leak on the edge of the suction cup which allows air at atmospheric pressure to fill up the cavity and thereby dissipate the vacuum and the attractive force acting on the suction cup. However, pulling on the suction cup can be difficult or impossible for small size cups and for a person wearing gloves.

Some commercial systems have additional flaps or lips on the rim of the suction cup that can be pulled or twisted to break the sealed contact between the edge and the surface. The leak created by this technique will enable the atmospheric air to flow under the suction cup, thereby eliminating the vacuum condition and releasing the cup from the surface. However, this mechanism requires manual manipulation and, if a user is wearing work gloves, this type of fine manipulation of a small feature cannot be done

Furthermore, depending on the design, typical but not exclusively for cam operated suction cups, is that the release of the cam and the associated relaxing of the suction cup does not necessarily cause the vacuum to be completely discharged. A residual vacuum can still exist under the suction cup. This could be caused by the user pushing the suction cup onto the surface. The natural deflection prior to the cam activation creates an initial vacuum adhesive and force. Unfortunately, this vacuum will remain after the relaxing of the suction cup, as there is no way for atmospheric air to enter the enclosed volume. The residual force can be significant enough that the removal of the suction cup could be challenging.

This is made worse if the user pulls on a cam handle to pull the suction cup off the surface. This manipulation will result in the vacuum to increase and result in an even higher adhesion force, and a corresponding increased release force is then required, often resulting in a removal force too high to be practical.

The present invention provides a release feature where removal is never a problem and which makes it much simpler and quicker to remove the suction cup from the surface.

### SUMMARY OF THE INVENTION

The present invention features a series of bumps spaced apart circumferentially arranged around the center of the vacuum cup, the bumps formed on the bottom of the suction cup. They can be variously shaped such as rounded projections, a ring segments, small ribs, etc. The bumps must be located a short distance in from the rim of the suction cup.

When installing the suction cup only a very little force is required to bring the outer rim beyond the bumps and into contact with the surface, creating a sealed volume which can cause a vacuum to be generated when the suction cup is on the surface.

A cam lever can be used to cause a lower edge of a conical operator to be forced down against the outer rim of the suction cup. I pull action from the cam when rotated, will automatically retract the bumps out of contact with the surface.

When the vacuum is generated the flexibility of the rubber bumps will cause the bumps to be drawn up and into the mass of the rubber elevated above the contact surface and allows the edge of the conical operator to seal the volume under the suction cup. This creates a vacuum which is maintained during the period which needs the vacuum cup to exist.

When the vacuum is reduced, as for example by releasing the cam, the bumps will naturally expand to again contact the surface at a point located inward from the outer rim. By the bumps pushing away from the surface, a path will occur to allow inflow of atmospheric air and thereby eliminate the vacuum and the need to eliminate the need for any significant effort to remove the suction cup.

The bumps act as a contact point and create a rotation point around which the rubber parts of the suction cups will rotate. As there is no real volume change, this rotation happens effortlessly, yet creating a simple leak releasing the vacuum and therefore the contact force.

In order for the suction cup to work, the bumps cannot be located at the outer edge itself. The edge should be able to seal off the volume under the suction cup when a lower end of a conical engagement piece is forced against the outer edge by operation of the cam. In line with the principle the bumps have to be near the edge so that their height will force the edge to lift the bumps from the surface and create an opening for the inflow of. For symmetry the bumps are located a short radial distance in from the outer edge of the suction cup.

### DESCRIPTION OF THE DRAWING FIGURES

FIG. 1 is a sectional view of a suction cup and operator components according to the present invention and a fragmentary depiction of a body having a surface on which a suction cup rests prior to development of a vacuum fixing the suction cup to a surface of a body.

FIG. 2 is the sectional view of the components shown in FIG. 1 with the suction cup now attached to the surface of the body by development of a vacuum beneath the suction cup by operation of a cam.

FIGS. 3-5 are bottom views of the suction cup shown in FIGS. 1 and 2 showing various possible shapes of the bump features on the underside of the suction cup.

FIGS. 3A-5A are side views of the three different examples of the shape of the bumps as shown in FIGS. 1 and 2.

FIGS. 6A-6C are simplified sectional views of three different states of a prior art suction cup and operator depicting how a suction cup according to the prior practice can unintentionally result in a vacuum to be generated when the vacuum cup is attempted to be released, making removal difficult.

FIGS. 7A-7C are sectional views of a suction cup and positioner according to the present invention, depicting the stages of operation thereof.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

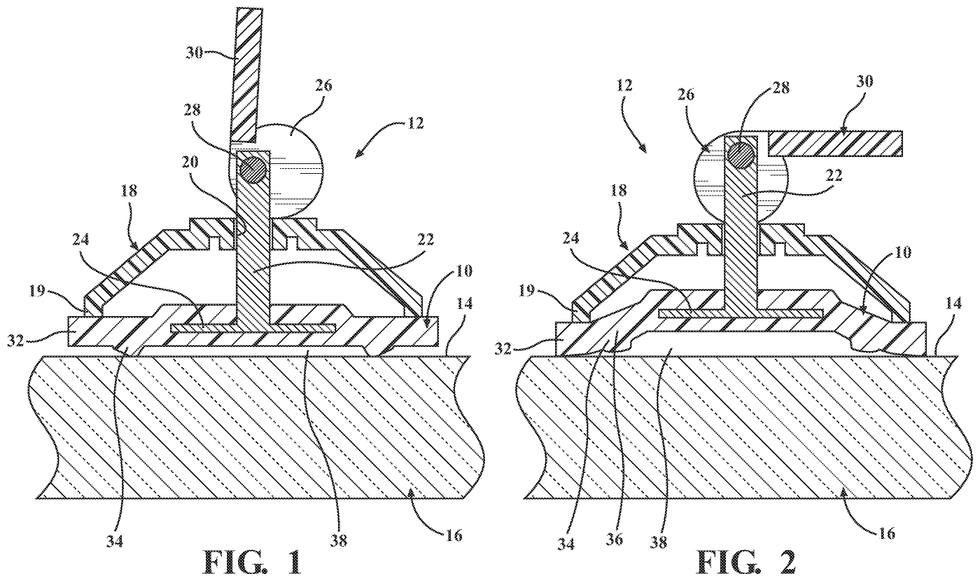

Referring to the drawings and in particular FIGS. 1 and 2, a suction cup 10 and sealing cone 12 according to the invention are shown with a series of bumps resting on the surface 14 of a body 16 to which the suction cup 10 is to be attached. It should be understood that there would be some tool or device (not shown) which will be mounted to the body 16 when the suction cup 10 is activated.

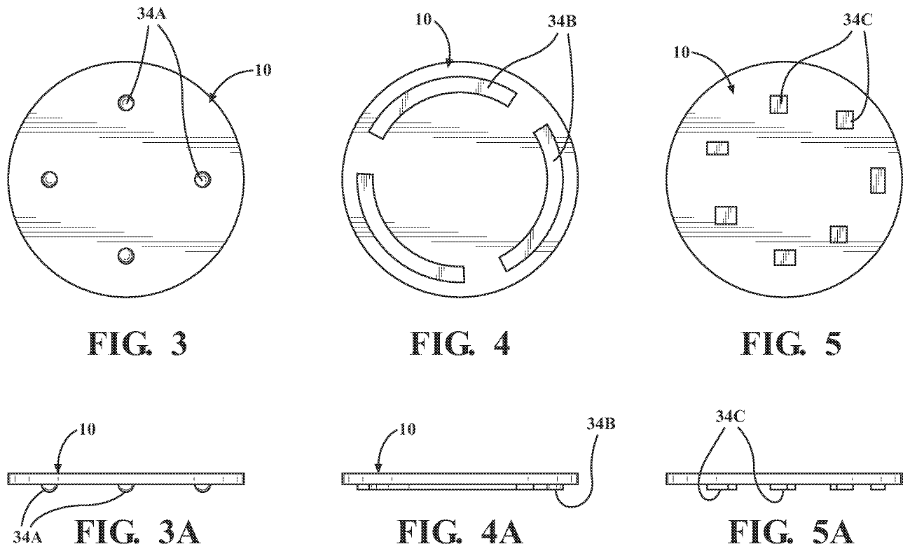

The suction cup 10 is typically round as seen in FIGS. 3-5.

A sealing cone 18 has a hole 20 in its top which slidably receives a pull rod 22.

The bottom 24 of the pull rod 22 has an integral disc 24 preferably of metal molded into the suction cup 10 to be attached thereto.

The upper end of the pull rod 22 has a round rotary cam 26 engaging the top of sealing cone 18 mounted thereto as by an eccentric pin 28 and engaged with the top of the sealing cone 18.

A cam operator handle 30 may be integral with the cam 26.

The bottom 19 of the sealing cone 18 is angled to be horizontal to the upper and outer portions of the suction cup 10.

When the cam 26 is rotated clockwise, this forces the outer part 32 of the suction cup 10 down to engage the surface 14 of the body 16 as seen in FIG. 2.

A series of circumferentially arranged bumps 34 normally protrude down as seen in FIG. 1 space in from the outer portion 32 of the suction cup 10. This is critical, as the outer portion 32 must be able to be sealed against surface 14, as seen in FIG. 2 when the cam 26 is operated to force the pull rod 22 up.

The bumps 34 are integrally formed with the bottom of the suction cup 10.

When the pull rod 22 is elevated and the sealing cone 18 is pushed down by rotation of the cam 26 the outer rim of the suction cup 10 is forced down while center portion 36 is elevated as seen in FIG. 2.

This stretches the intervening portion 36 and raises the bumps 34 out of contact with the surface 14 to generate a strong vacuum as the volume of the now sealed space 38 increases substantially.

To release the suction cup 10, the cam 26 is rotated in the opposite direction to reduce the volume 38 and the vacuum force, and the bumps 34 then vent the space 38 as in FIG. 1 so no vacuum can be developed or maintained.

FIGS. 3-5 and 3A-5A shown various other shapes of the bumps 34A, 34B, and 34C can be used.

The important consideration is that the bumps 34 have to not form a continuous contour to insure venting through the intervening spaces.

They also must be radially spaced in from the outer rim of the suction cup 10 to allow sealing when the sealing cone 18 is lowered but insure venting the space 38 when the suction cup 10 is lowered by the presence of the now expanded bumps 34.

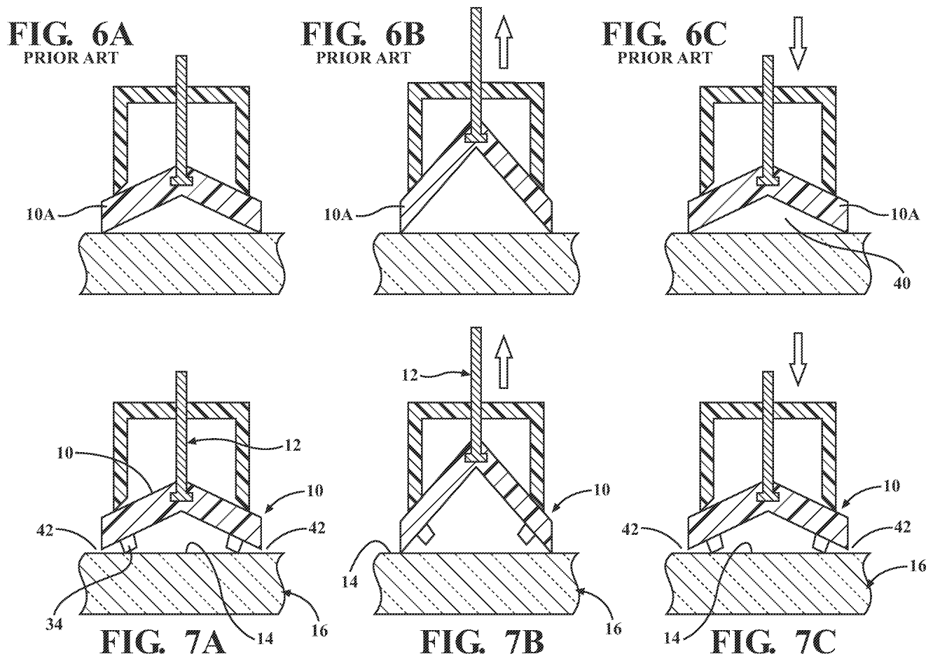

FIGS. 6A-6C and 7A-7C shows the difference in result of conventional practice and the present invention.

FIG. 6A shows that a vacuum can be inadvertently created by an up movement of the sealed vacuum cup 10A as the space below is sealed.

After the vacuum cup 10A is activated by upward movement the sealed engagement causes a strong desired vacuum to be developed (FIG. 6B).

When the center of the cup 10A is lowered as seen in FIG. 7C there may remain a remaining sealed space 40.

Any effort to pull up to vent causes an increase in vacuum and resultant force making removal difficult.

In FIGS. 7A-7C the space 38 is always vented at the rim by the gap 42 created by bumps 34 so no vacuum is created.

1. An apparatus for attaching a suction cup to a surface by establishing a vacuum in a space defined beneath said suction cup and over said surface;
said suction cup having a circumferentially arranged integral series of spaced apart bumps projecting downwardly from an undersurface of said suction cup and spaced inwardly a short distance from an outside rim of said suction cup;
a pull rod attached to said suction cup elevated by a manually operated cam mechanism which can mechanism also lowers said sealing cone having a bottom engaged with an outer rim end of said suction cup to hold the same down as said pull rod elevates a central portion of said suction cup to increase the volume of the space above said surface and thereby create a vacuum drawing said suction cup against said surface.

2. The apparatus according to claim 1 wherein said bumps are pulled up and away from said surface as said pull rod raises said central portion of said suction cup, said bumps are pushed into said suction cup portion where said bumps are located to increase a clearance with respect to said surface.

3. The apparatus according to claim 2 wherein said cam mechanism comprises a round member having an upper end of said pull rod connected to a periphery of said cam member so as to be raised or lowered by movement of a handle attached thereto.

4. A method for attaching a suction cup to a surface by the step of establishing a vacuum between said surface and a central part of said suction cup, said step including mounting one end of a vertical pull rod to said central portion of said suction cup and at the other end to a cam mechanism able to be operated to use said pull rod and said central portion of said suction cup to increase the volume of a space beneath said suction cup while holding an outer rim of said suction cup against said surface to seal said space and thereby create said vacuum.

5. The method according to claim 4 wherein a circumferentially spaced apart series of downwardly extending bumps are formed on said suction cup contacting said surface prior to raising said pull rod to vent said space to the atmosphere and initially prevent formation of a vacuum.
